(19) United States
(12) Patent Application Publication
(10) Pub. No.: US 2012/0003615 A1
(43) Pub. Date: Jan. 5, 2012

(54) Weight Loss System

(76) Inventor: Donald Lee Ochs, Crested Butte, CO (US)

(21) Appl. No.: 13/173,914

(22) Filed: Jun. 30, 2011

Related U.S. Application Data
(60) Provisional application No. 61/359,936, filed on Jun. 30, 2010.

(51) Int. Cl. G09B 19/00

(52) U.S. Cl. 434/127

(57) ABSTRACT

A comprehensive integrated weight loss system combines regimens of exercise, nutrition and motivation with a focus upon raising a glycemic threshold to overcome insulin resistance. The diet may be fine-tuned by using feedback mechanisms to assess whether an individual is using a glycemic load that is correct for their individual body.

### RELATED APPLICATIONS

This application claims benefit of priority to provisional application Ser. No. 61/359,936 filed Jun. 30, 2010, incorporated herein by reference.

### BACKGROUND

Americans are increasingly overweight, despite a variety of weight loss products that are commercially available. Government reports based on the body-mass index (BMI) show that 60% of Americans (183,000,000 persons) are currently overweight or obese. At least 85% of these people have some degree of insulin resistance. This resistance causes fat accumulation around the stomach area, which is the least healthy place for human bodies to store fat.

Insulin is a fat storage hormone, and resistance causes the body to produce too much insulin. This overproduction results in blood sugar crashes and increased fat storage. Eating too many of the wrong carbohydrates can lead to glucose shock as the body responds by secreting insulin that quickly removes the excess glucose, i.e., sugar, from the bloodstream as stored fat. The plunging blood sugar levels cause increased appetite, cravings for sweets, and a pronounced lack of energy sometimes known as the mid-afternoon crash.

The term ‘biochemical individuality’ describes the fact that people are all as different on the inside as we are on the outside. This means that people do not all react the same way to the same foods or drugs. By way of example, many people have a genetic predisposition towards insulin resistance. Of the total population, about 25% have a low insulin response to carbohydrates. These lucky few can eat carbohydrates all day long and seldom put on a pound. On the other end of the spectrum are 25% of the population that can scarcely even look at a carbohydrate without putting on weight. The remaining 50% of the population has an elevated insulin response to highly processed carbohydrates. Evolutionarily speaking, processed carbohydrates are new and unnatural to our digestive systems, and this problem usually gets worse with age.

This means that there is no such thing as a one-size-fits-all diet. Yet, nearly all of today's diet products are geared to this one-size-fits-all mentality. A popular diet may be metabolically suited for the ten percent or so of the population that happens to function best on that type of a diet, but may also be completely wrong for the metabolic requirements of the other 90%. The marketplace has many different types of diets that all claim successful outcomes for the few, but the many have miserable long-term results. Additionally, most diet products and systems only address a specific part of the entire problem. Some address weight loss through diet. Others address weight loss through some sort of exercise. Still others include a diet plan and a suggested exercise routine. Some diet regimens focus on improved heart health/longevity. Others are based on hypnotherapy to re-train the subconscious mind to change eating and/or exercise habits.

### SUMMARY

The present disclosure overcomes the problems outlined above and advances the art by providing a comprehensive integrated weight loss system that is selectively tunable to work with any type of biochemical individuality. This is done by using, at the core of the system, the concept of a glycemic threshold to find balance in a system that integrates nutrition, exercise, motivation and hypnotherapy.

According to one embodiment, a method of dieting is provided such that an individual exercises a sufficient amount to reduce insulin resistance and so also raises a glycemic threshold that may be unique to the individual. The individual diets according to a nutritional regimen that limits glycemic load. The individual is motivated by use of an electronic system that performs hypnotherapy. These steps are performed contemporaneously over an interval of time exceeding at least about eight weeks. The dieting includes fine-tuning the diet by feedback mechanisms selected from the group consisting of cravings, energy level, hunger, rate of weight loss and combinations thereof to accommodate the individual's glycemic threshold.

In one aspect the method of dieting may include exercising where there is a progression from walking to interval exercise over the interval of eight weeks.

In one aspect the fine-tuning of the diet may include prioritizing the feedback mechanisms in the order of cravings, energy level, hunger, rate of weight loss and using a combination of these mechanisms

In one aspect the motivating may include using an audio format that simultaneously plays a hypnotherapist's voice in two patterns, a first pattern that is dominant in the foreground and a second format that is passive in the background. In one aspect the motivating may include playing brain entrainment sounds simultaneously with the hypnotherapist's voice in two patterns.

### BRIEF DESCRIPTION OF THE DRAWINGS

FIG. 1 shows a glycemic threshold that is lowered by the phenomenon of insulin resistance;

FIG. 2 is used for purposes of comparison to FIG. 1 and shows a balance induced by the response of a human body to exercise and diet, thus raising the glycemic threshold;

FIG. 3 shows a method of weight loss that combines exercise, nutrition, and motivational regimens;

FIG. 4 shows various age-dependant heart rate values for use in the exercise regimen of FIG. 3;

FIG. 5 shows a nutritional regimen according to one embodiment of FIG. 3;

FIG. 6 shows a data structure for a compact disc that may be used in the motivational regimen according to one embodiment of FIG. 3;

FIG. 7 shows an electronic system that may be used to facilitate a method of dieting;

FIG. 8 shows a process that may be implemented through the use of software to control the system FIG. 7.

### DETAILED DESCRIPTION

### Dietary Principles

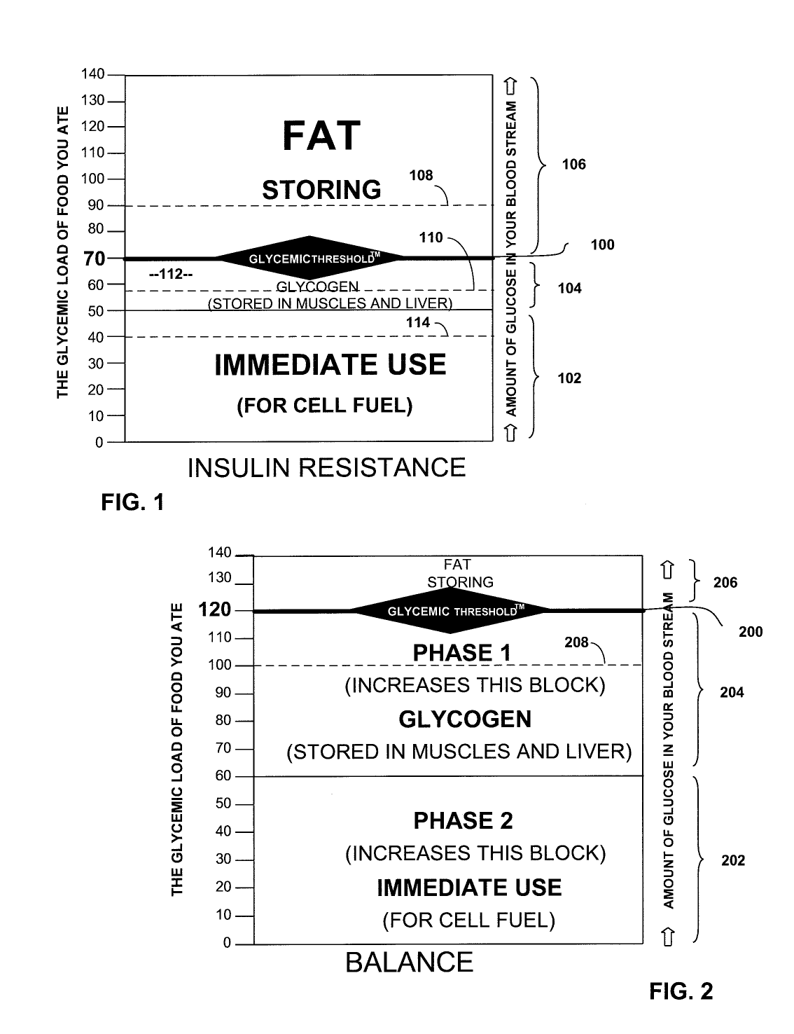

A comparison between FIG. 1 shows the object of an integrated weight loss system according to the present disclosure. The actual numbers are unimportant may vary by individual and interval of time. FIG. 1 shows a glycemic threshold 100 at a level of about 70 in a case where insulin resistance exists in the body of a person. A first zone 102 spans an interval from 0 to 50 indicating a level of glucose that is available for immediate use by cells. A second zone 104 spans an interval from about 50 to 70 to present a magnitude of 20 representing glycogen that is stored in muscles and the liver. Glycogen is an analogue to starch and functions as a secondary long-term energy storage molecule. Glycogen provides an energy reserve that can be quickly mobilized to meet a sudden need for glucose, but one that is less compact than the energy reserves of lipids. Raising the amount of glucose in the blood stream above the glycemic threshold 100 results in fat-storing in the third zone 106.

More particularly, the glycemic threshold 100 is a boundary level of blood glucose separating the body's responses into either fat storage in zone 106 or glycogen/glucose consumption in zones 102/104. The glycemic threshold exists for a particular person at a particular time. Thus, the glycemic threshold 100, which as shown at a glycemic load of 70 in FIG. 1, may be 20 for another individual and 120 for still another individual. The person with a glycemic threshold at a glycemic load of 120 will be able to eat more carbohydrates without suffering from fat storage than the person with a glycemic threshold at a glycemic load of 20.

In one example, an individual characterized by FIG. 1 may eat a meal with a glycemic load at level 108, exceeding the glycemic threshold 100. The resulting excess glucose in the bloodstream causes the body to produce insulin which, in turn, reduces the blood glucose level by causing the glucose to be converted and stored as fat. Certain foods cause greater use of insulin, such that there can high and low spikes of blood glucose. The lowering of blood glucose caused by the release of insulin results in a number of symptoms including cravings for certain foods and loss of energy. These effects occur for anyone who exceeds their glycemic threshold, but are exacerbated by the phenomenon of insulin resistance which can be mitigated by exercise.

In another example, the individual eats a meal with a glycemic load of 60, which falls below the glycemic threshold 100. Since the glycemic threshold 100 has not been exceeded, there is a deficit in area 112. As glycogen in the liver depletes, the body secretes gucagon. Intense exercise may raise the level of glucagon secretion. The glucagon signals the body to raise blood sugar by releasing stored fat. The individual may adjust diet even further to a glycemic load 114 for more severe weight loss, but it is difficult to do this on a sustained basis.

### Exercise Regimen

As contrasted to FIG. 1, FIG. 2 shows a balance that may be achieved by the instrumentalities of the present disclosure to overcome or reduce the amount of insulin resistance. The glycemic threshold is raised to a glycemic load of 120, as compared to the glycemic load of 70 in FIG. 1. This is accomplished by building lean muscle mass. The exercise expands the amount of glucose that is available for immediate use, where zone 202 spans a glycemic load interval from 0 to 60 as compared to the 0 to 50 glycemic load in zone 102 of FIG. 1. Similarly, glycogen zone 204 spans an interval from about 60 to 120 to present a magnitude of 60, as compared to the magnitude of 20 in zone 104 of FIG. 1. The relative expansion of zones 202, 204 reduces the amount of fat storing in zone 206 as compared to zone 106 of FIG. 1. The relative expansion of zones 204 and 202 may be accomplished by what are respectively described herein as Phase 1 and Phase 2 exercise regimens, which are conducted simultaneously with nutritional and motivation regimens.

Ideally, the glycemic load of a person's diet fall below the exercise-adjusted glycemic threshold to level 208 as indicated in FIG. 2. According to the principles described herein below, the glycemic threshold 200 is maintained at this elevated state through an exercise regimen while the diet is adjusted to a level less than the glycemic threshold 200. Thus, such factors as dietary cravings, reduced energy levels, hunger, and rate of weight loss may be used to adjust the glycemic load to a level that approximates the ideal glycemic threshold for an individual.

The Phase 1 exercise regimen has an object of slowing people down to reduce insulin resistance. It is not the stomach, liver, or some other internal organ that causes insulin resistance. Resistance comes primarily from the muscles. In particular, the slow-twitch muscle fibers contain most of the body's mitochondria. When these muscles lack responsiveness to insulin, this causes the pancreas to secrete up to eight times the normal amount of insulin to process the carbohydrates that have been eaten, as compared to cases where insulin resistance does not exist. Accordingly, the answer to reversing insulin resistance is to increase the insulin sensitivity of the muscles through exercise.

Researchers have pinpointed the biochemical reason that muscles lose sensitivity to insulin when a person fails to exercise. The problem arises because mitochondria in the muscles go into a dormant state when they are not used enough. If one fails to exercise his or her muscles for a day or two, the mitochondria go into a sleep mode in which they burn fewer calories and stop responding to insulin. Exercising the muscles wakes up these sleeping mitochondria. The muscles then remain sensitive to insulin for 24 to 48 hours following exercise and then they shut down again.

When it comes to reversing insulin resistance, one does not necessarily need to exercise harder—just smarter. One solution to reversing insulin resistance lies in increasing the activity of the mitochondria through walking. Researchers have determined that it only takes between twenty and 30 minutes of easy walking to regain the muscle's sensitivity to insulin. Thus, the Phase-1 exercise regimen is to get out and walk.

The increased insulin sensitivity caused by walking coupled with the elimination of glucose surges by following the nutrition regimen, as described below, reverses insulin resistance and facilitates weight loss. To begin by way of example, a person may start off easy and slowly to condition the slow-twitch muscle fibers by walking for at least twenty minutes every other day. As the person becomes stronger, or if the person is already in pretty good shape when starting the regimen, the distance walked may be gradually increased to 40 minutes every other day. The person may walk more than that, but the additional walking is unnecessary to reverse insulin resistance.

Studies have shown that people consistently lose weight if they walk forty minutes four times a week. That is about two miles every other day. The walking is preferably accomplished using an easy pace without pushing the effort too hard. Panting and shortness of breath indicate that the pace is too high. This Phase 1 walking is preferably a low-intensity exercise that at most times keeps the heart rate below 65% of its maximum suggested rate. By way of example, it is fine to briefly exceed 65% as when walking up hill, but it is desirable to avoid turning this into a cardio-type exercise. This is because cardio workouts at this stage can actually thwart the weight loss efforts and do not further increase insulin sensitivity. Once a person establishes a fitness base from walking and has begun to increase insulin sensitivity, it is advisable to start to add in Phase 2 exercises for faster fat loss.

One object of the Phase 2 exercise regimen is to speed up to maximize fat loss. While Phase 1 stops the accumulation of excess fat by eliminating insulin resistance through low-intensity exercise, Phase 2 burns up stored fat by using high-intensity short duration exercise also known as interval exercise. Interval exercise builds lean muscle mass that leads to increased metabolism. Studies prove that fifteen minutes of interval exercise may burn more fat than is disposed of during two hours of endurance exercise. In fact, interval exercise has been shown to burn up to nine times more fat for every calorie burned than endurance exercise.

Short bursts of interval exercise signal the body that storing energy as fat is inefficient, since the body never exercises long enough to use the fat during each interval session. The exercise is fueled by burning the readily available glucose from carbohydrates, which is stored in the muscles—not in the fat. Glucose stored in the muscles is a high-energy output fuel, while fat is a low energy output fuel. The interval exercise uses up most of the high-output glucose. The body must then replace the spent glucose immediately after it stops exercising. This facilitates maximum fat loss as the body accesses its fat stores to convert stored fat back into carbohydrates and replenish the spent glucose in the muscles. This post exercise fat-to-glucose conversion is energy intensive, burning up to nine times more fat in the long run than does endurance exercise does. Replacing the glucose in the muscles is an ‘afterburn’ process that continues up to 24 hours after the exercise is complete.

This explains why the Phase 2 interval exercise regimen requires fifteen minutes of work, but yields 24 hours of results. There is more fat loss in less time than with traditional cardio workouts.

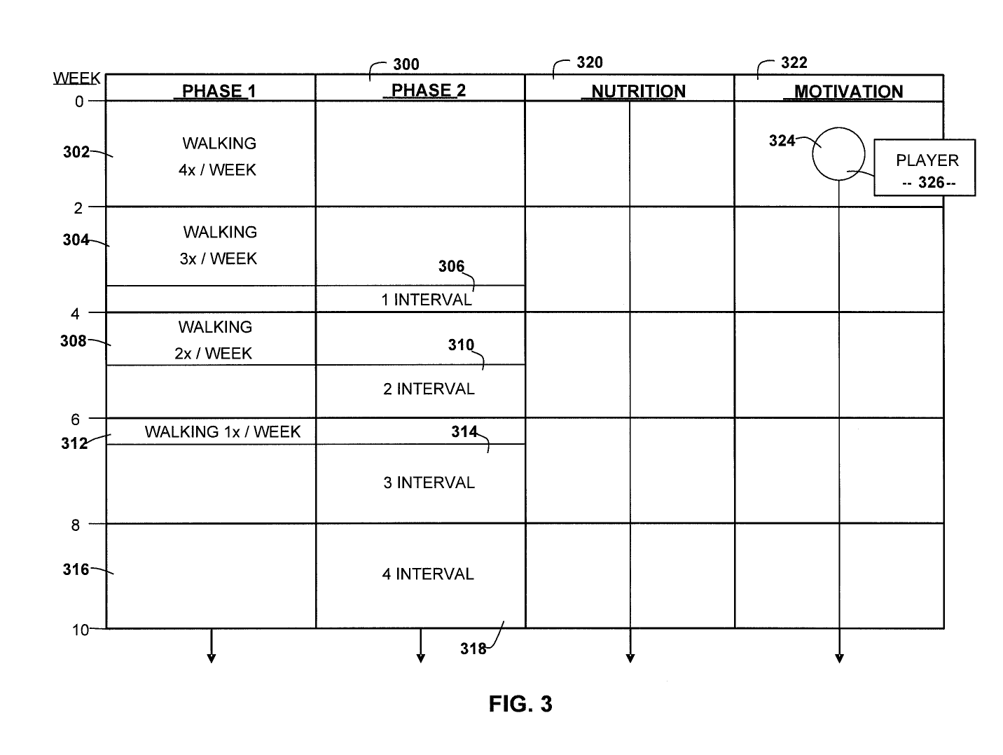

FIG. 3 shows a process 300 of progressing a person from Phase 1 to Phase 2. A person begins Phase 1 at week 0 by walking 302 at least four times a week for the first 2 weeks. With some variability depending on the person's overall conditioning when starting the program, as may be assessed by the 60% heart rate when walking as discussed above, the person may replace one of the Phase 1 walking sessions with a Phase 2 session after the second week. Weeks three and four then entail three days of walking 304 and one day of fifteen minutes of interval exercise 306. Weeks 5 and 6 then entail two days of walking 308 and two days of fifteen minutes of interval exercise 310. Similarly, weeks seven and eight next entail one day of walking 312 and three days of fifteen minutes of interval exercise 314. After week eight, walking is optional 316 and the person moves to four days of twenty minutes of interval exercise 318. Insulin resistance is greatly reduced and the Phase 2 exercises facilitate achieving weight loss goals.

Additional low intensity exercise may be added, such as a day or two of walking, swimming or biking. Nonetheless, when performing the Phase 2 exercises, recovery and re-building are almost as important as the exercise itself. It is preferred that the Phase 2 exercises not be done two days in a row. With this guidance, it is permissible to place a Phase 1 day between two days of Phase 2 exercise, but it is desirable to always provide at least one day off each week. This allows the body to make the adaptive changes it needs to make in response to these workouts.

The Phase 2 exercises may be designed by experts and taught, for example, by DVD and/or a workbook that outline the exertion-and-rest intervals. Regardless of which type of Phase 2 exercise is performed, the main principles of interval exercise are the same:
1. Create an “oxygen debt” with each exertion period
2. Rest after each exertion period until the heart rate comes down to below 60% of maximum suggested heart rate (MHR).
3. Make each succeeding interval just a little bit harder than the last one finishing the workout with the last set going all-out.
4. Always keep the length of the ‘exertion’ part of the Phase 2 workout, including warm-up and cool-down, under 20 minutes.
5. Switch it up. There are many different types of Phase 2 exercises that achieve the same fat-burning results. Keep giving the body new challenges by not repeating the same exercises all the time. By progressively challenging the body in new and harder ways, one may keep making important gains in overall fitness and health. When a particular Phase 2 routine becomes too easy something is preferably done to make the routine more difficult in some way, or else there may be a switch to a new routine (for example from sprinting on a flat surface to sprinting up a hill).

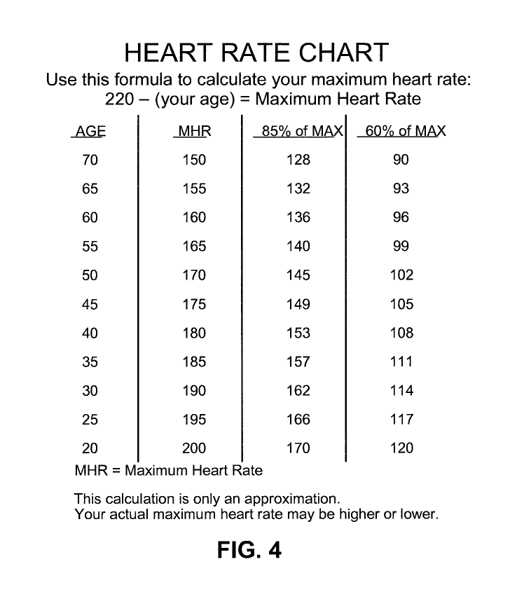

FIG. 4 is a chart providing zones for suggested age-dependant maximum heart rates that may be used in Phase 2. The Phase 2 interval exercise is intended to raise the heart rate to a minimum level of at least 85% of the suggested maximum. It is further suggested that each subject performing exercise consult a physician before beginning any of these exercises to assure that this will be a safe practice. It is further recommended that the subject not exceed 100% of the suggested maximum rate in FIG. 4. After resting until the heart rate reaches 60% of the suggested maximum rate, the subject may begin another interval to accumulate the target fifteen or twenty minutes of interval exercise.

### Nutritional Regimen

It will be appreciated that a balanced diet requires three categories of food including proteins, carbohydrates, and fat. Various diets propose to eliminate one or more of these categories, and may be temporarily effective in facilitating weight loss, but the weight loss is merely a temporary phenomenon because it is difficult or impossible for people to maintain themselves on such diets for a long period of time. Although this is contrary to what most people believe, fat in the diet is not responsible for most weight gain. While it is true that there are good fats and bad fats, as discussed in more detail below, people mostly gain weight because they eat too many carbohydrates, i.e., at each meal they exceed the glycemic threshold. This may be controlled by proper diet.

In reference to FIGS. 1 and 2, the reduced glycemic load at levels 110, 114, 208 to create the deficit 112 is governed by diet that is adjusted using feedback signals from body to ascertain the suitability of diet. The nutritional regimen is a low-glycemic load diet. This is not a low-calorie or portion-restricted diet. People on this regimen may eat until they are satisfied at every meal. As shown in FIG. 3, the nutritional regimen 320 is performed simultaneously with the Phase 1 and Phase 2 exercise regimens.

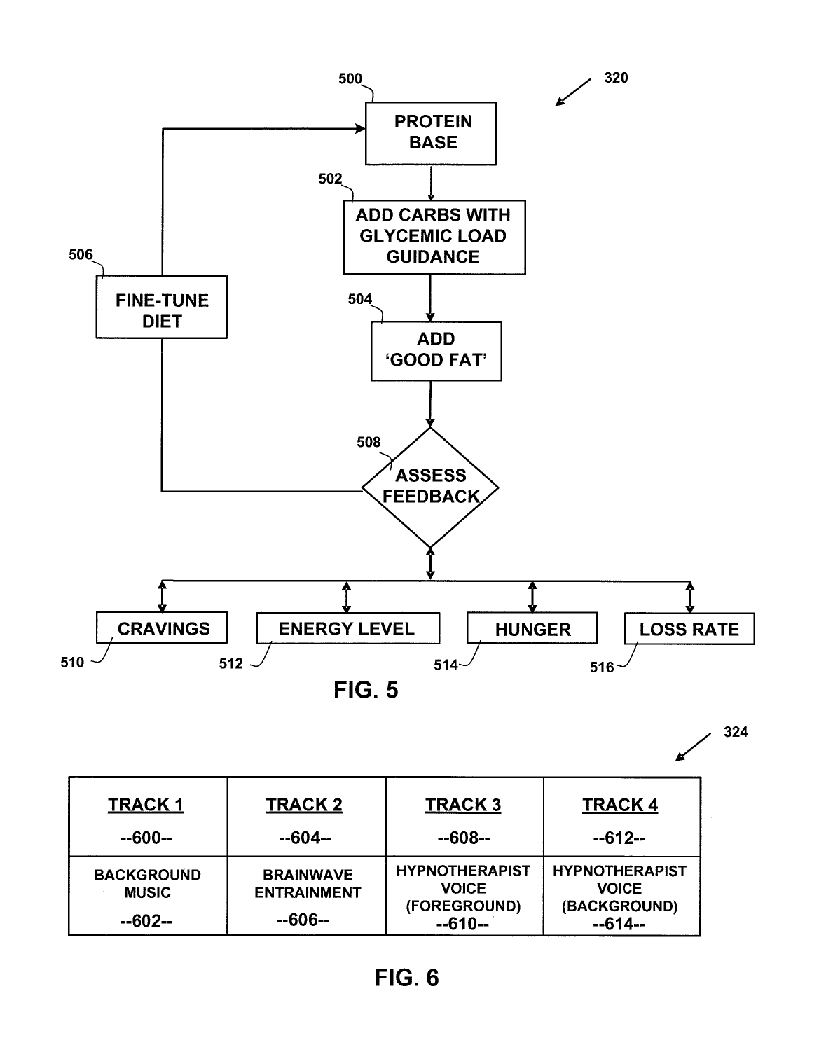

FIG. 5 provides additional detail regarding the nutritional regimen 320. Each meal and snack are constructed around a protein base 500, which is a serving of lean protein. One suggestion is that each person consume a range of protein from 0.6 gram to 1 gram of protein each day for every pound of lean muscle mass the person has. Eggs, beef, chicken, pork, lamb, fowl, seafood, and dairy are all appropriate choices. Free-range and grass-fed cuts of meat and dairy products are preferred, as commercially produced products may contain high levels of growth hormone or antibiotics. Legumes and other non-animal sources of protein are usually poor choices as they have too high a glycemic load to mitigate insulin resistance. Portion sizes are preferably satisfying, but do not overfill. Protein consumption builds and maintains lean muscle mass, which in turn increases metabolism.

Carbohydrates may be added 502 to the diet with guidance from the Glycemic Load Chart shown as Table 1 below. A person may decide which carbohydrate(s) they wish to have and then, using Table 1, determine how large of a serving size is permissible while still keeping the total glycemic load of the meal under 100. In the case of smacks, the glycemic load is preferably 50 or less. For fastest weight loss, it is recommended that people eliminate all bread, pasta, rice and potatoes from the diet and assure that the total daily glycemic load never exceeds 400 as the cumulative glycemic load of all meals and snacks. Later on, after people have achieved their weight loss goal, they may gradually add some starch to the diet, preferably remembering to keep the total glycemic load at each meal under 100 and the cumulative daily total under 400.

By way of example, Table 1 shows that it only takes a little bit of bread or pasta to reach a glycemic load of 100, whereas a person may eat a large serving of fruit or vegetables and still stay below 100. It is permissible to mix more than one type of carbohydrate, such as in a soups or salad, at a meal so long as the glycemic loads of all the carbohydrates added together are fewer than the glycemic threshold of the individual.

TABLE 1
Glycemic Loads of Various Foods*

| FOOD | DESCRIPTION | GLYCEMIC LOAD |
|---|---|---|
| CEREALS | | |
| All Bran | 1 cup | 100 |
| Bran Flakes | 1 cup | 170 |
| Cheerios | 1 cup | 125 |
| Corn Flakes | 1 cup | 210 |
| Fruit Loops | 1 cup | 150 |
| Grape Nuts | 1 cup | 310 |
| Oatmeal (instant) | 1 cup (cooked) | 160 |
| Oatmeal (slow cooked) | 1 cup (cooked) | 130 |
| Raisin Bran | 1 cup | 230 |
| Rice Chex | 1 cup | 285 |
| Shredded Wheat | 1 cup | 325 |
| Special K | 1 cup | 150 |
| Total (whole grain) | 1 cup | 200 |
| BREADS | | |
| Angel Food Cake | 1 slice | 110 |
| Bagel (plain) | 1 whole | 300 |
| Croissant | 1 medium | 170 |
| English Muffin | 1 whole | 220 |
| French Bread | 1 thick slice | 280 |
| Hamburger Bun | 4½″ (top & bottom) | 190 |
| Kaiser Roll | 1 roll | 210 |
| Low Carb Bread | 1 slice | 40 |
| Pancake | 5″ diameter | 260 |
| Pita | 1 medium | 190 |
| Pound Cake | 1 small slice | 240 |
| Pumpernickel | 1 slice | 60 |
| Rye (light) | 1 slice | 85 |
| Sourdough | 1 slice | 110 |
| Taco Shell (hard) | 1 medium | 70 |
| Tortilla (corn) | 6″ diameter | 80 |
| Tortilla (flour) | 6″ diameter | 90 |
| Tortilla (low carb) | 6″ diameter | 40 |
| Waffle | 7″ diameter | 200 |
| White Bread | 1 slice | 100 |
| Whole Wheat Bread | 1 slice | 85 |
| GRAINS | | |
| Amaranth | 1 cup cooked | 210 |
| Barket | 1 cup cooked | 190 |
| Bulgur | 1 cup cooked | 220 |
| Cornmeal | 1 cup cooked | 370 |
| Couscous | 1 cup cooked | 320 |
| Millet | 1 cup cooked | 220 |
| Quinoa | 1 cup cooked | 180 |
| Rice (basmati) | 1 cup cooked | 270 |
| Rice (brown) | 1 cup cooked | 220 |
| Rice (white) | 1 cup cooked | 280 |
| PASTAS | | |
| Asian Bean Noodles | 1 cup cooked | 120 |
| Capellini | 1 cup cooked | 160 |
| Fettuccine | 1 cup cooked | 140 |
| Linguine | 1 cup cooked | 180 |
| Macaroni | 1 cup cooked | 180 |
| Macaroni and Cheese | 1 cup cooked | 250 |
| Spaghetti (boiled 5 min) | 1 cup cooked | 140 |
| Spaghetti (boiled 15 min) | 1 cup cooked | 170 |
| Spaghetti (boiled 20 min) | 1 cup cooked | 210 |
| Vermicelli | 1 cup cooked | 130 |
| SNACKS | | |
| Chicken Nuggets | 3 nuggets | 70 |
| chocolate (dark) | 1 oz | 70 |
| Cookies (avg. all types) | 1 medium 3″ | 110 |
| Corn Chips | 1 oz | 120 |
| Donut | 1 large glazed | 240 |
| French Fries | 1 medium order | 220 |
| Fruit Candy Roll-Up | 1 roll | 110 |
| Graham Wafers | 2 full crackers | 160 |
| Jelly Beans | 1 oz | 220 |
| M & M's (peanut) | 1 small bag (49.3 g) | 90 |
| Muffin (blueberry) | 2½″ diameter | 170 |
| Muffin (bran) | 2½″ diameter | 150 |
| Pastry | 1 medium | 150 |
| Pizza (supreme) | 1 slice thin crust | 90 |
| Popcorn (microwave) | 2 cups popped | 60 |
| Potato Chips | 1 oz | 60 |
| Pretzels | 1 oz | 150 |
| Rice Cakes | 1 oz | 180 |
| Snickers Bar | 1 bar (2 oz) | 230 |
| Vanilla Wafers | 4 wafers | 160 |
| Wheat Crackers | 16 crackers (31 g) | 135 |
| CONDIMENTS | | |
| Artificial Sweeteners | 1 packet | 0 |
| Barbecue Sauce | 1 tablespoon | 25 |
| Blue Cheese Dressing | 2 tablespoons | 10 |
| Butter | 1 pad | 0 |
| Caesar Dressing | 2 tablespoons | 10 |
| Cocktail Sauce | 2 tablespoons | 20 |
| Coconut Oil | 2 tablespoons | 0 |
| French Dressing | 2 tablespoons | 15 |
| Grape Jelly | 1 tablespoon | 25 |
| Guacamole | 2 tablespoons | 0 |
| Honey | 1 teaspoon | 15 |
| Honey Mustard Dressing | 2 tablespoons | 20 |
| Horseradish Sauce | 1 tablespoon | 10 |
| Italian Dressing | 2 tablespoons | 10 |
| Ketchup | 1 tablespoon | 20 |
| Mayonnaise | 2 tablespoons | 20 |
| Mustard (brown) | 1 tablespoon | 0 |
| Mustard (yellow) | 1 tablespoon | 0 |
| Olives (green, black) | 5 olives | 0 |
| Olive Oil | 2 tablespoons | 0 |
| Peanut Butter | 2 tablespoons | 10 |
| Pickle Relish | 1 tablespoon | 20 |
| Ranch Dressing | 2 tablespoons | 10 |
| Salsa | 2 tablespoons | 10 |
| Soy Sauce | 2 tablespoons | 20 |
| Spices (all types) | 1 teaspoon | 0 |
| Steak Sauce | 2 tablespoons | 20 |
| Strawberry Jam | 1 tablespoon | 25 |
| Syrup (maple) | 2 tablespoons | 80 |
| Table Sugar | 1 teaspoon | 35 |
| Thousand Island Dressing | 2 tablespoons | 20 |
| Tomato Sauce (meatless) | ½ cup | 40 |
| Vinegar and Oil Dressing | 2 tablespoons | 20 |
| (balsamic) | | |
| Wasabi | 2 tablespoons | 20 |
| BEVERAGES | | |
| Apple Juice (unsweetened) | 6 fl oz glass | 80 |
| Beer (premium | 12 fl oz bottle/can | 30 |
| dark/amber) | | |
| Beer (domestic standard) | 12 fl oz bottle/can | 15 |
| Beer (lite or low carb) | 12 fl oz bottle/can | 10 |
| Carrot Juice | 6 fl oz glass | 70 |
| Chocolate Milk (low fat) | 8 fl oz glass | 80 |
| Coffee (black) | 6 fl oz glass | 0 |
| Colas (average) | 12 fl oz bottle/can | 220 |
| Cranberry Juice | 6 fl oz glass | 110 |
| Leading Sports Drink | 16 fl oz bottle | 215 |
| Grapefruit Juice | 6 fl oz glass | 70 |
| (unsweetened) | | |
| Milk (Skim) | 1 cup | 45 |
| Milk (2%) | 1 cup | 40 |
| Orange Juice | 6 fl oz glass | 90 |
| Orange Soda | 12 fl oz bottle/can | 300 |
| Pineapple Juice | 6 fl oz glass | 110 |
| (unsweetened) | | |
| Spirits | 1½ fl oz | 15 |
| Tea (black, unsweetened) | 6 fl oz glass | 0 |
| Tea (green, unsweetened) | 6 fl oz glass | 0 |
| Tea (iced, sweetened) | 12 fl oz bottle/can | 200 |
| Tomato Juice | 6 fl oz glass | 30 |
| Water | as much as you want! | 0 |
| Wine (white) | 5 fl oz glass | 15 |
| Wine (red) | 5 fl oz glass | 15 |
| VEGETABLES | | |
| Artichoke | ½ cup | 55 |
| Asparagus | ½ cup | 10 |
| Beans (green, yellow) | 1 cup cooked | 30 |
| Beets | ½ cup | 30 |
| Broccoli | ½ cup | 10 |
| Brussels Sprouts | ½ cup | 20 |
| Cabbage | 1 cup cooked | 20 |
| Carrot (raw) | 1 medium size | 10 |
| Carrot (cooked) | ½ cup | 30 |
| Cauliflower | ½ cup | 10 |
| Celery | 1 medium stalk | 0 |
| Collard Green | ½ cup | 20 |
| Cucumber | ½ cup sliced | 10 |
| Corn (canned, creamed) | ½ cup | 180 |
| Corn (on the cob) | 1 medium ear | 160 |
| Lettuce (all types) | 1 cup | 10 |
| Mushrooms | ½ cup | 10 |
| Okra | ½ cup sliced | 20 |
| Onion | ½ cup sliced | 20 |
| Peas | ½ cup | 40 |
| Peppers (bell) | ½ medium size | 10 |
| Pickle (dill) | 1 medium size | 10 |
| Potatoes (baked) | 1 medium size | 260 |
| Potatoes (instant, mashed) | ½ cup | 120 |
| Potatoes (French fries) | 1 medium order | 220 |
| Potatoes (sweet) | ½ cup | 170 |
| Radish | ½ cup | 10 |
| Spinach (fresh) | 1 cup | 10 |
| Sprouts | ½ cup | 10 |
| Squash (summer) | ½ cup | 15 |
| Squash (winter) | ½ cup | 60 |
| Tomato | 1 medium size | 15 |
| Yams | ½ cup | 120 |
| LEGUMES | | |
| Beans (baked) | ½ cup cooked | 100 |
| Beans (garbanzo) | ½ cup cooked | 50 |
| Beans (kidney) | ½ cup cooked | 40 |
| Beans (lentil) | ½ cup cooked | 40 |
| Beans (lima) | ½ cup cooked | 60 |
| Beans (navy) | ½ cup cooked | 40 |
| Beans (pinto) | ½ cup cooked | 60 |
| Chickpeas | ½ cup cooked | 70 |
| Edamame (soy) | ½ cup cooked | 30 |
| Peanuts (salted) | ¼ cup | 10 |
| FRUITS | | |
| Apple | 1 medium | 75 |
| Apricot (dried) | 1 cup | 240 |
| Avocado | ½ large | 10 |
| Banana | 1 medium | 120 |
| Blackberries | 1 cup | 40 |
| Blueberries | 1 cup | 70 |
| Cantaloupe | 1 cup | 80 |
| Cherries | 1 cup | 80 |
| Dates | 5 medium | 290 |
| Fruit Cocktail (drained) | 1 cup | 200 |
| Grapefruit | ½ large | 35 |
| Grapes | 1 cup | 65 |
| Kiwi | 1 medium | 50 |
| Mango | 1 cup | 130 |
| Orange | 1 medium | 75 |
| Papaya | 1 cup | 70 |
| Peach | 1 medium | 30 |
| Pear | 1 medium | 60 |
| Pineapple | 1 large slice | 50 |
| Plum | 1 medium | 40 |
| Prunes (stewed) | 1 cup | 340 |
| Raisins | ½ cup | 280 |
| Raspberries | 1 cup | 40 |
| Strawberries | 1 cup | 40 |
| Watermelon | 1 cup | 80 |
| NUTS & SEEDS | | |
| Almonds | ¼ cup | 0 |
| Cashews | ¼ cup | 25 |
| Flax Seeds | ¼ cup | 40 |
| Hazelnuts | ¼ cup | 0 |
| Macadamia | ¼ cup | 0 |
| Pecans | ¼ cup | 0 |
| Peanuts (legumes) | ¼ cup | 10 |
| Pistachios | ¼ cup | 20 |
| Pumpkin Seeds | ¼ cup | 40 |
| Sunflower Seeds | ¼ cup | 50 |
| Walnuts | ¼ cup | 0 |
| DAIRY PRODUCTS | | |
| Butter | 1 pad | 0 |
| Cheese (American) | 1 single | 0 |
| Cheese (hard, all types) | 1 oz | 0 |
| Cottage Cheese (2%) | ⅓ cup | 25 |
| Cream Cheese (plain) | 1 oz | 0 |
| Eggs | 2 large | 0 |
| Ice Cream (vanilla, regular | ½ cup | 65 |
| fat) | | |
| Ice Cream (vanilla, low | ½ cup | 100 |
| fat) | | |
| Milk (soy) | 1 cup | 80 |
| Milk (whole) | 1 cup | 40 |
| Tofu (frozen dessert) | ½ cup | 350 |
| Yogurt (plain) | ¾ cup | 45 |
| Yogurt (low fat | ¾ cup | 150 |
| with added fruit) | | |
| MEATS | | |
| Beef (grass fed) | 8 oz steak | 0 |
| Buffalo | 8 oz steak | 0 |
| Chicken | 8 oz | 0 |
| Crab | 4 large legs | 0 |
| Duck | 8 oz | 0 |
| Elk | 8 oz filet | 0 |
| Fish | 8 oz filet | 0 |
| Ham (deli sliced) | 6 oz | 0 |
| Hamburger (80% lean) | 8 oz | 0 |
| Lamb | 8 oz | 0 |
| Lobster | 2 medium tails | 0 |
| Pork | 8 oz | 0 |
| Shrimp | 1 cup cooked | 0 |
| Turkey | 8 oz | 0 |
| Veal | 8 oz | 0 |
| Venison | 8 oz | 0 |

*The glycemic load (GL) is calculated as
GL = NC*GI/10, where
NC is net carbohydrates per serving in grams,
GI is glycemic index,
NC = TC − F
TC is total carbohydrates per serving and
F is grams of fiber per serving.

‘Good fat’ may be added 504 to round out the meal. Contrary to popular opinion, eating fat does not make one fat. Excess carbohydrate is what makes people fat. Fat is, however, high in calories and therefore should not be overeaten. Fat is an essential part of the ideal ‘fuel’ mixture required to properly nourish our bodies. Fat adds a satisfying feel to food and may be an important part of adopting a lifelong diet plan. Fat also slows the rate of absorption of other foods into the bloodstream and helps control insulin resistance. Certain types of fat, such as trans-fats and too much saturated fat, are generally regarded as being harmful so their use should be minimized. Visible fats should be trimmed from meats. Use of saturated fats should be minimized in deference to the preferred use of mono and poly-unsaturated fats. Olive oil is preferred for cooking Avocados, whole olives, nuts and seeds are preferred sources of fats. Butter and cheese are acceptable fat choices. The object is to add fat to suit taste, as many protein sources naturally contain fat. Fat is preferably added to a minimum level that is required to satisfy a person's taste.

The diet may be fine-tuned 506 for maximum fat loss. Just as no two people are the same on the outside, no two people are the same on the inside either. The perfect ratio of macronutrients for one person's metabolism may be slightly different than the perfect ratio of macronutrients that are ideal for another person. There really is no such thing as a one-size-fits-all diet. Our bodies provide feedback signals that may be assessed 508 enabling the fine-tuning of step 506 to meet individual metabolic requirements. One key to fine-tuning the macronutrient ratio of the diet is to understand how to interpret the feedback from the body. The clues we are looking for are, in this order of importance: (1) Cravings, (2) Energy, (3) Hunger, and (4) Rate of Weight Loss.

CRAVINGS 510. Food cravings may arise, particularly for sweets or fatty foods, as opposed to a feeling of satisfaction one to two hours after a meal. These cravings are an indication that there was too high of a glycemic load at the last meal. This is remedied in step 506 by lowering the glycemic load at the next meal to see if this eliminates future cravings. This is possible because elevated insulin levels produce a rapid drop in blood sugar, and this drop results in cravings. When the blood sugar level gets too high, the body does not achieve its ideal ‘fuel mixture.’ Metabolism is then not working optimally for weight loss and energy production. If one craves certain foods after a meal, as opposed to being merely hungry, it is possible to lower the glycemic load of the next meal to 90 or 80 and carefully watch how the body reacts. Some people may need to go all the way down to a glycemic load of 20 or 30 to completely eliminate food cravings. One may also experiment with glycemic load levels and observe how the body reacts. The fine-tuning 506 works best by keeping protein intake consistent but freely adjusting carbohydrate and fat intake.

ENERGY LEVEL 512. People practicing this nutritional regimen may make a record of how their energy level feels from one to two hours after they finish a meal. By way of example, a person may have good energy or, alternatively, feel lethargic and just want to lie down on the couch. If the energy level drops significantly after a meal, there were probably too many carbohydrates. Again, lower the glycemic load at the next meal and take notice of how the energy level responds. When a person hits an ideal macronutrient ratio, they will have plenty of excess energy and feel great. This is the body's normal response to food. Cravings and low energy are signs of poor nutrition.

HUNGER 514. The nutritional regimen described herein is not a low-calorie diet. As long as a person fine-tunes the diet 506 to adjust glycemic load to minimize cravings and maximize energy levels, the person may eat as much food as they need to satisfy appetite. It is recommended that a person who cannot go at least 3 to 4 hours between meals without becoming hungry, as opposed to craving something, should try increasing the amount of protein and fat at the next meal. Remember that fat contributes to overall satisfaction with a meal. This slows the rate of entry of food into the bloodstream. People who do overeat, regardless of how closely they hit their ideal macronutrient ratio, will feel a crash in energy. Guidance is to stop eating when the stomach feels about 75% full and then wait ten minutes before eating any more.

RATE OF WEIGHT LOSS 516. The rate of healthy weight loss is ideally one to two pounds per week, but may be more or less according to individual preferences. By way of example, if a person losing ten pounds or more in a week there is a very good chance that much of the loss is undesirably water weight loss, and so the rate of loss should be slowed by drinking plenty of water. If the weight loss is occurring at too fast a rate then the person may raise the glycemic load if the diet. On the other hand, if a person has plateaued such that the weight loss has ceased entirely or the person is actually gaining weight, there is a need to lower the glycemic load of the diet even further.

### Motivational Regimen

It will be appreciated that a motivational regimen 322 (see FIG. 3) may be performed simultaneously with the Phase 1, Phase 2 and nutritional regimens.

To lose weight, and keep it off, overweight people who practice the instrumentalities described herein need to cease eating the way that made them fat and start eating the way that will keep them thin. Understanding why we do what we do is part of changing what we do. It is very common for people on a diet to understand on a conscious level that overeating is causing problems and is something they truly want to avoid, but they often cannot stop themselves from overeating time and again. These well intentioned people are able to use willpower for a limited time, but sooner or later they lose motivation and fall back into bad old ways. They are involved in a never-ending struggle to lose weight.

These things happen because many such unwanted behaviors as overeating, drug abuse, smoking, and anxiety just to name a few, are driven by the unconscious programming of our minds, not conscious thoughts and intentions. Thus, what people consciously want to do is often not what they end up doing. For this reason, the mind sometimes works against weight loss goals rather than towards them. Repetition is the key to replacing old unresourceful eating habits with new ones.

Everyone is hypnotizable—it's just a matter of to what degree. Some people will find the suggestions becoming fully effective within the first week or two. For others it may take a few months until one really feels the urge to eat a healthy diet and enjoy the exercise. In either case it does work—but people have to stick with it long enough to fully replace old unresourceful habits with the new hypnotic suggestions. Hypnotism is a proven technique with the ability to affect permanent changes in behavior. People do not acquire poor eating habits overnight, and so they cannot realistically expect to change the poor habits overnight. Motivation is accomplished by repeatedly listening to an audio presentation, such as may be found on a compact disk (CD) or DVD 324, which may be played using a standard electronic system, such as audio player 326, as are known to the art. Each time a person listens to the motivation CD 324, the suggestions become a little more powerful and compelling.

This may be accomplished, for example, by listening to the motivation CD 324 every night when a person goes to bed. The person puts on a set of headphones, plays the motivational CD 324, gets comfortable, and lies back to relax. It is perfectly fine if the person falls asleep during the session. It is well known that people begin every night's sleep in the ‘awakened’ Beta state indicated as a brain wave frequency of from 12 hz to 38 hz. The person is alert and conscious in a normal waking state that is not useful for hypnotherapy. People progressively relax down through Alpha (8 hz to 12 hz) and Theta (3 hz to 8 hz), finally reaching the deep dreamless Delta state (0.2 hz to 3 hz) associated with sleep. People do not normally stay in one state for the entire night, but move frequently from Delta up to Theta (the state where REM sleep occurs) and back again. Hypnotherapy just mimics this progression of relaxation. The motivation CD 324 may be reviewed at any time.

The motivational CD 324 may be structured according to one embodiment as shown in FIG. 6. Four separate sound tracks produce a motivational experience. Track 1 (denoted 600) is a background track containing music 602 designed for relaxation, but is not intended to put a subject to sleep. Track 2 (604 in FIG. 6) contains a series of low tones or beats that increase and decrease in frequency and intensity throughout the session. These are known in the hypnotic arts as brainwave entrainment sounds 606 and facilitate a hypnotic state. Track 3 (608 in FIG. 6) presents an expert hypnotherapist's voice delivering suggestions in the audible foreground 610 of the session. Track 4 (612 in FIG. 6) is also the hypnotherapist's voice, but at a much subtler background level 614. By design, a listener is drawn to listen to the main voice track, but the lower-volume suggestions in the background are extremely effective at reaching the subconscious while the listener is in the hyper-suggestible Theta state. The tracks 608, 612 preferably contain no ‘subliminal’ suggestions. One track is louder, and thus easier to hear, but both tracks are completely audible and contain all of the motivational statements.

The motivational statements reinforce the instrumentalities discussed above by providing a positive and encouraging message in a command-like format, e.g., “You will monitor the glycemic load of each meal. You will not exceed a glycemic load of 100 at each meal. You will enjoy interval training.” It is recommended that people following these instrumentalities listen to the motivation CD at least once every day for the first sixty days—or more. After that, use may occur less frequently, especially if a person feels a return to bad old habits or if there is a need for extra help, such as may occur around the holidays.

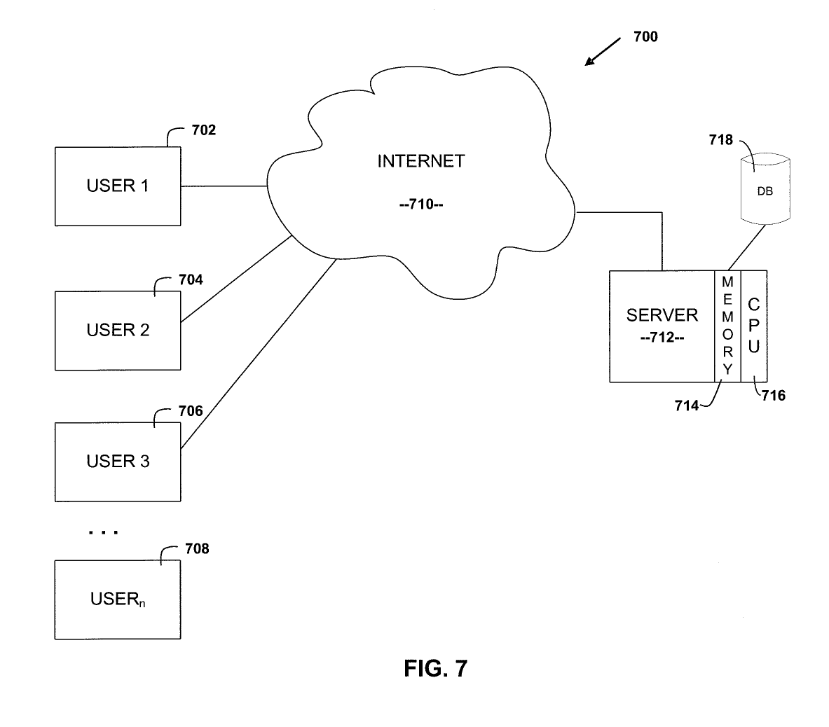

FIG. 7 shows an expert system 700 that may be provided to implement the foregoing regimens by way of programmable circuitry. It will be appreciated that the system structure is schematic in nature and may be implemented using single or distributed processing, as well as single or distributed databasing.

A community of n users 702, 704, 706, 708 connect to the Internet 710 using conventional telecommunications protocols as are known in the art. This connection establishes each user with an account on server 712, which has an electronic memory 714 and a programmably controlled processor 716. A database provides tracking for the user accounts, as well as useful data, such as the glycemic load data of Table 1, a selection of recipes for suggested meals that are designed by nutritional experts to carry a predetermined glycemic load, Phase 1 and Phase 2 exercise regimens designed by experts in the field of exercise, and motivational presentations designed by experts in the field of motivational psychology and hypnotherapy, all in accord with the principles described above.

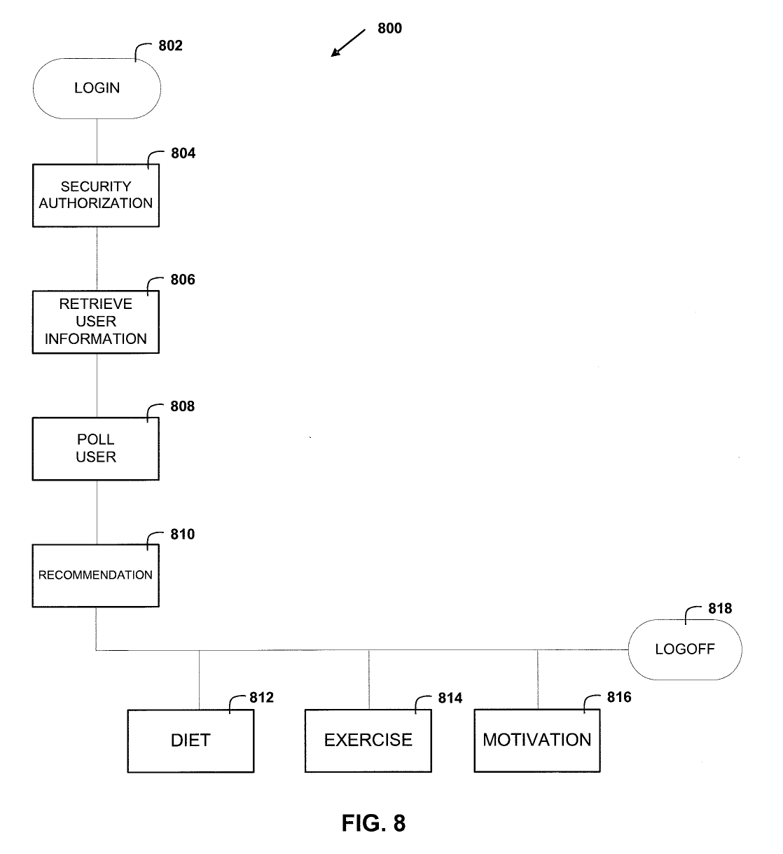

FIG. 8 shows a process 800 that may be implemented through the use of software to control the system 700 of FIG. 7, governing the operation thereof. Upon connecting to the system 700, each user is prompted to login 802. Security authorization 804 may entail the creation of a new user account, after which access may be granted using a password or biometric authorization for existing accounts. Server 712 then retrieves the user account information 806, which is a history of the user's progress, or lack thereof, in following the principles outlined above. The user is then polled to ascertain the glycemic load of meals eaten between the last session and the current session, as well as exercises performed in that interval of time. The user is also polled to assess cravings 510, energy level, 512, hunger 514, and rate of weight loss for purposes of fine-tuning the diet 506 as described in context of FIG. 5. The server 712 then analyzes these responses using a set of expert-defined rules to make recommendations 810. The user then interacts with the system 700 to receive these recommendations for diet 812, exercise, 814 and motivation 816.

By way of example, if the user has been eating meals that exceed the glycemic threshold, the user may be provided with recommended recipes meals that will reduce this to a new trial level to ascertain at the next login whether symptoms of cravings and energy level are diminished or eliminated. Similarly, if the glycemic threshold is so low that it might be substantially raised by the effects of exercise as described above in context of FIG. 2, the system 700 may provide recommendation for improved exercise routines. Alternatively, the system 700 may recommend different exercise routines for a change of pace. Failure to adhere to any of these recommendations may be followed by motivational selections 816, which may also be provided in the normal course as recommended by a system of expert rules. The user concludes each session with logout 818.

The foregoing discussion teaches by way of example and not by limitation. As such, those skilled in the art will appreciate that the embodiments may be subjected to insubstantial changes without departing from the true scope and spirit of the invention. The inventor hereby states his intention to rely upon the Doctrine of Equivalents to protect the full scope of what is claimed.

1. A method of dieting that comprises an individual:
(a) exercising a sufficient amount to raise a glycemic threshold;
(b) dieting according to a nutritional regimen that limits glycemic load; and
(c) motivating by use of an electronic system that performs hypnotherapy;
wherein the above steps (a), (b), and (c) are performed contemporaneously over an interval of time exceeding at least about eight weeks, and
the step (b) includes fine-tuning the diet by feedback mechanisms selected from the group consisting of cravings, energy level, hunger, rate of weight loss, and combinations thereof to accommodate the individual's glycemic threshold.

2. The method of claim 1, where the step (a) of exercising includes a progression from walking to interval exercise over the interval of eight weeks.

3. The method of claim 1, where the fine-tuning of step (b) includes prioritizing the feedback mechanisms in the order of cravings, energy level, hunger, and rate of weight loss, with use of more than one feedback mechanism.

4. The method of claim 1, where the step (c) of motivating includes using an audio format that simultaneously plays a hypnotherapist's voice in two patterns, a first pattern that is dominant in the foreground and a second format that is passive in the background.

5. The method of claim 4, where the step (c) of motivating includes playing brain entrainment sounds simultaneously with the hypnotherapist's voice in two patterns.

6. A system providing for automated dietary recommendations, comprising:
means for providing user access to an electronic system;
means for polling user responses to obtain data regarding the an individual's diet, exercises performed by the individual, whether the individual is experiencing food cravings, whether the individual is experiencing a low energy level, whether the individual is experiencing hunger, and rate of weight loss; and
means for assessing the data using an electronic system programmed with a system of expert-defined rules to provide recommendations as to the individual's diet regimen, exercise regimen, and motivational regimen.
exercising a sufficient amount to reduce insulin resistance and so also raise a glycemic threshold;
(b) dieting according to a nutritional regimen that limits glycemic load; and
(c) motivating by use of an electronic system that performs hypnotherapy;
wherein the above steps (a), (b), and (c) are performed contemporaneously over an interval of time exceeding at least about eight weeks, and
the step (b) includes fine-tuning the diet by feedback mechanisms selected from the group consisting of cravings, energy level, hunger, rate of weight loss, and combinations thereof to accommodate the individual's glycemic threshold.
